(19) United States
(12) Patent Application Publication
(10) Pub. No.: US 2005/0085584 A1
(43) Pub. Date: Apr. 21, 2005

(54) Aqueous adhesive dispersions

(76) Inventors: Rudiger Musch, Bergisch Gladbach (DE); Knut Panskus, Leverkusen (DE); Wolfgang Henning, Kurten (DE); Heinz-Werner Lucas, Bergisch Gladbach (DE)

Correspondence Address: BAYER MATERIAL SCIENCE LLC, 100 BAYER ROAD, PITTSBURGH, PA, 15205, US

(21) Appl. No.: 10/939,879

(22) Filed: Sep. 13, 2004

(30) Foreign Application Priority Data
Sep. 18, 2003 (DE) 10343676.6
Feb. 19, 2004 (DE) 102004008055

(51) Int. Cl. C08L 1/00

(52) U.S. Cl. 524/493; 524/507

(57) ABSTRACT

Aqueous polymer dispersions based on polyurethanes that include a) at least one polyurethane dispersion having a mean particle size of from 60 to 350 nm, and b) at least one polychloroprene dispersion having a mean particle size of from 60 to 300 nm, and
c) at least one aqueous silicon dioxide dispersion having a particle diameter of the SiO₂ particles of from 1 to 400 nm. The dispersion can be prepared by admixing a mixture of b) and c) with a). The dispersions can be used in adhesive compositions.

### CROSS REFERENCE TO RELATED PATENT APPLICATION

The present patent application claims the right of priority under 35 U.S.C. §119 (a)-(d) of German Patent Application No. 103 43 676.6, filed Sep. 18, 2003.

### BACKGROUND OF THE INVENTION

1. Field of the Invention

The invention relates to aqueous polymer dispersions based on polyurethanes and polychloroprenes, to a process for their preparation and to their use.

2. Description of the Prior Art

Adhesives based on polyurethane are predominantly solvent-containing adhesives which are applied to both substrates to be bonded and dried. By subsequently joining the two substrates together under pressure at RT or after heat activation, a bond having high initial strength is obtained immediately after the joining operation.

For ecological reasons there is a growing need for suitable aqueous adhesive dispersions which can be processed into corresponding aqueous adhesive formulations. Such systems have the disadvantage that the adhesive layers must be dried after application and the substrates can only be joined together after prior heat activation of the dry adhesive film. It is not possible to join the substrates together at room temperature.

With polychloroprene dispersions, on the other hand, it is possible, by combination with aqueous silicon dioxide dispersions, to produce mixtures which are able to bond substrates at room temperature while still in the wet state. It is found, however, that various substrates, e.g. plasticised PVC, which can successfully be bonded by polyurethane dispersion adhesives after heat activation, can be bonded only unsatisfactorily by means of aqueous polychloroprene dispersions at room temperature.

The preparation and use of an aqueous formulation using polyurethane and polychloroprene dispersions together is at present not possible, however, because polychloroprene dispersions are usually in the form of strongly alkaline polymer dispersions in water. Under these conditions, polyurethane is hydrolysed and the polymer chains are degraded. Even after lowering the pH of the formulation using appropriate agents such as, for example, aminoacetic acid, such mixtures are unstable because small amounts of HCl separate from the polychloroprene during storage, which likewise leads to degradation of the polyurethane chains.

The object underlying the present invention was to provide aqueous polyurethane adhesive compositions which, after application to the substrates to be bonded and after joining, exhibit a high initial strength, especially in the wet state (wet strength), and which are stable to hydrolysis.

### SUMMARY OF THE INVENTION

The present invention is directed to an aqueous polymer dispersion that includes a) at least one polyurethane dispersion having a mean particle size of from 60 to 350 nm, b) at least one polychloroprene dispersion having a mean particle size of from 60 to 300 nm, and c) at least one aqueous silicon dioxide dispersion having a particle diameter of the SiO₂ particles of from 1 to 400 nm.

The present invention is also directed to a process for preparing the above-described polymer dispersion by mixing the polychloroprene dispersion (b) with the silicon dioxide dispersion (c) and optionally additives conventionally used as adhesive auxiliary substances, and mixing the polyurethane dispersion (a) into the mixture of (b) and (c).

The present invention is further directed to an adhesive composition that includes the above-described polymer dispersion.

The present invention is additionally directed to substrates bonded together by the above-described polymer dispersion and in particular to when the substrates are structural components of shoes or are shoes.

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.”

It has been found that, by suitably combining polyurethane dispersions, aqueous polychloroprene dispersions, which are stable to HCl separation, and aqueous silicon dioxide dispersions, it is possible to produce adhesives which exhibit a high initial strength, wet strength and stability to heat after bonding.

The use of silicic acid products for various applications is known from the prior art. While solid SiO₂ products are widely used for controlling rheological properties, as fillers or as adsorbents, silicon dioxide dispersions (silica sols) are predominantly used as binders for various inorganic materials, as polishing compounds for semi-conductors or as flocculation partners in reactions of colloid chemistry. For example, EP-A 0 332 928 discloses the use of polychloroprene latices in the presence of silica sols as an impregnating layer in the production of fireproofing elements. Pyrogenic silicic acids are described in FR-A 2 341 537 and FR-A 2 210 699 in combination with polychloroprene latices for the production of flame-resistant foam finishings or for bitumen coating, and in JP-A 06 256 738 in combination with chloroprene-acrylic acid copolymers.

The tempering of polychloroprene dispersions having a high solids content is known from the prior art. EP-A 0 857 741 describes obtaining a product having good reactivity towards dispersed polyisocyanates by storing the dispersion at 50° C. It is a noticeable disadvantage that this procedure markedly lowers the pH of the dispersion and significantly increases the electrolyte content. Both reduce the stability on storage and during formulation to adhesives.

The production of crosslinked (gel-containing) polychloroprene dispersions is also known. This polymerisation is described in U.S. Pat. No. 5,773,544. Polymerisation to a high monomer conversion yields gel-containing polymer dispersions which are distinguished in adhesive formulations by their high stability to heat. The low storage stability of the dispersions is a noticeable disadvantage here too.

The present invention provides aqueous polymer dispersions comprising
a) at least one polyurethane dispersion having a mean particle size of from 60 to 350 nm, preferably from 70 to 300 nm, as determined by laser correlation spectroscopy, and
b) at least one polychloroprene dispersion having a mean particle size of from 60 to 300 nm, preferably 60 to 200 nm, more preferably 60 to 150 nm and most preferably from 60 to 120 nm as determined by laser correlation spectroscopy, and
c) at least one aqueous silicon dioxide dispersion having a particle diameter of the SiO₂ particles of from 1 to 400 nm, preferably from 5 to 100 nm, particularly preferably from 8 to 60 nm (determined by the method of G. N. Sears, Analytical Chemistry Vol. 28, N. 12, 1981-1983, December 1956, the relevant portions of which are herein incorporated by reference).

The polyurethane dispersions (a) to be used according to the invention comprise polyurethanes (A) which are reaction products of the following components:
A1) polyisocyanates,
A2) polymeric polyols and/or polyamines having mean molar weights of from 400 to 8000,
A3) optionally mono- or poly-alcohols or mono- or poly-amines or amino alcohols having molar weights up to 400,
   and at least one compound selected from
A4) compounds having at least one ionic or potentially ionic group and/or
A5) non-ionic compounds which have been rendered hydrophilic.

A potentially ionic group within the scope of the invention is a group which is capable of forming an ionic group.

The polyurethanes (A) are preferably prepared using from 7 to 45 wt. % of A1), from 50 to 91 wt. % of A2), from 0 to 15 wt. % of A5), from 0 to 12 wt. % of ionic or potentially ionic compounds A4) and optionally from 0 to 30 wt. % of compounds A3), the sum of A4) and A5) being from 0.1 to 27 wt. % and the sum of the components being 100 wt. %.

Particularly preferably, the polyurethanes (A) are composed of from 10 to 30 wt. % of A1), from 65 to 90 wt. % of A2), from 0 to 10 wt. % of A5), from 3 to 9 wt. % of ionic or potentially ionic compounds A4) and optionally from 0 to 10 wt. % of compounds A3), the sum of A4) and A5) being from 0.1 to 19 wt. % and the sum of the components being 100 wt. %.

Very particularly preferably, the polyurethanes (A) are prepared using from 8 to 27 wt. % of A1), from 65 to 85 wt. % of A2), from 0 to 8 wt. % of A5), from 3 to 8 wt. % of ionic or potentially ionic compounds A4) and optionally from 0 to 8 wt. % of compounds A3), the sum of A4) and A5) being from 0.1 to 16 wt. % and the sum of the components being 100 wt. %.

Suitable polyisocyanates (A1) are aromatic, araliphatic, aliphatic or cycloaliphatic polyisocyanates. It is also possible to use mixtures of such polyisocyanates. Examples of suitable polyisocyanates are butylene diisocyanate, hexamethylene diisocyanate (HDI), isophorone diisocyanate (IPDI), 2,2,4- and/or 2,4,4-trimethyl-hexamethylene diisocyanate, the isomers of bis(4,4′-isocyanatocyclo-hexyl)methane or mixtures thereof of any desired isomer content, isocyanato-methyl 1,8-octane diisocyanate, 1,4-cyclohexylene diisocyanate, 1,4-phenylene diisocyanate, 2,4- and/or 2,6-toluylene diisocyanate, 1,5-naphthylene diisocyanate, 2,4′- or 4,4′-diphenylmethane diisocyanate, triphenylmethane 4,4′,4″-triisocyanate or derivatives thereof having a urethane, isocyanurate, allophanate, biuret, uretdione, iminooxadiazinedione structure and mixtures thereof. Preference is given to hexamethylene diisocyanate, isophorone diisocyanate and the isomers of bis(4,4′-isocyanatocyclohexyl)methane and mixtures thereof.

Preference is given to polyisocyanates or polyisocyanate mixtures of the mentioned type having only aliphatically and/or cycloaliphatically bonded isocyanate groups. Very particularly preferred starting components (A1) are polyisocyanates or polyisocyanate mixtures based on HDI, IPDI and/or 4,4′-diisocyanatodicyclohexylmethane.

Also suitable as polyisocyanates (A1) are any desired polyisocyanates having a uretdione, isocyanurate, urethane, allophanate, biuret, iminooxadiazinedione and/or oxadiazinetrione structure which have been prepared by modification of simple aliphatic, cycloaliphatic, araliphatic and/or aromatic diisocyanates and are composed of at least two diisocyanates, as are described, for example, in J. Prakt. Chem. 336 (1994) p. 185-200.

Suitable polymeric polyols or polyamines (A2) have an OH functionality of at least from 1.5 to 4, such as, for example, polyacrylates, polyesters, polylactones, polyethers, polycarbonates, polyester carbonates, polyacetals, polyolefins and polysiloxanes. Preference is given to polyols in a molar weight range of from 600 to 2500 having an OH functionality of from 2 to 3.

Suitable hydroxyl-group-containing polycarbonates are obtainable by reaction of carbonic acid derivatives, e.g. diphenyl carbonate, dimethyl carbonate or phosgene, with diols. Suitable diols are, for example, ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methyl-1,3-propanediol, 2,2,4-trimethyl-1,3-pentanediol, dipropylene glycol, polypropylene glycols, dibutylene glycol, polybutylene glycols, bisphenol A, tetrabromobisphenol A as well as lactone-modified diols. The diol component preferably contains from 40 to 100 wt. % hexanediol, preferably 1,6-hexanediol and/or hexanediol derivatives, preferably those which, as well as containing terminal OH groups, contain ether or ester groups, e.g. products obtained by reaction of 1 mol. of hexanediol with at least 1 mol., preferably from 1 to 2 mol., of caprolactone according to DE-A 1 770 245 or by etherification of hexanediol with itself to form di- or tri-hexylene glycol. The preparation of such derivatives is known from DE-A 1 570 540, for example. The polyether-polycarbonate diols described in DE-A 3 717 060 can also be used.

The hydroxyl polycarbonates should preferably be linear. However, they may optionally be branched slightly by the incorporation of polyfunctional components, especially low molecular weight polyols. There are suitable for this purpose, for example, glycerol, trimethylolpropane, 1,2,6-hexanetriol, 1,2,4-butanetriol, trimethylolpropane, pentaerythritol, quinitol, mannitol and sorbitol, methyl glycoside, 1,3,4,6-dianhydrohexites.

Suitable polyether polyols are the polytetramethylene glycol polyethers known per se in polyurethane chemistry, which can be prepared, for example, by polymerisation of tetrahydrofuran by cationic ring opening.

Further suitable polyether polyols are polyethers, such as, for example, the polyols of styrene oxide, propylene oxide, butylene oxides or epichlorohydrin, especially of propylene oxide, prepared using starter molecules.

Suitable polyester polyols are, for example, reaction products of polyhydric, preferably dihydric and optionally additionally trihydric, alcohols with polyvalent, preferably divalent, carboxylic acids. Instead of the free polycarboxylic acids it is also possible to use in the preparation of the polyesters the corresponding polycarboxylic acid anhydrides or corresponding polycarboxylic acid esters of lower alcohols or mixtures thereof. The polycarboxylic acids may be of aliphatic, cycloaliphatic, aromatic and/or heterocyclic nature and may optionally be substituted, for example by halogen atoms, and/or unsaturated.

The components (A3) are suitable for terminating the polyurethane prepolymer. There come into consideration for that purpose monofunctional alcohols and monoamines. Preferred monoalcohols are aliphatic monoalcohols having from 1 to 18 carbon atoms, such as, for example, ethanol, n-butanol, ethylene glycol monobutyl ether, 2-ethylhexanol, 1-octanol, 1-dodecanol or 1-hexadecanol. Preferred monoamines are aliphatic monoamines, such as, for example, diethylamine, dibutylamine, ethanolamine, N-methylethanolamine or N,N-diethanolamine and amines of the Jeffamin® M series (Huntsman Corp. Europe, Belgium) or amino-functional polyethylene oxides and polypropylene oxides.

Also suitable as component (A3) are polyols, aminopolyols or polyamines having a molecular weight below 400, a large number of which are described in the literature.

Preferred components (A3) are, for example:
a) alkane-diols and -triols, such as ethanediol, 1,2- and 1,3-propanediol, 1,4- and 2,3-butanediol, 1,5-pentanediol, 1,3-dimethylpropanediol, 1,6hexanediol, neopentyl glycol, 1,4-cyclohexanedimethanol, 2-methyl-1,3-propanediol, 2-ethyl-2-butylpropanediol, trimethylpentanediol, position-isomeric diethyloctanediols, 1,2- and 1,4-cyclohexanediol, 2,2-dimethyl-3-hydroxypropionic acid (2,2-dimethyl-3-hydroxypropyl ester), hydrogenated bisphenol A [2,2-bis(4-hydroxycyclohexyl)propane], trimethylolethane, trimethylolpropane or glycerol,
b) ether diols, such as diethylene diglycol, triethylene glycol, tetraethylene glycol, dipropylene glycol, tripropylene glycol, 1,3-butylene glycol or hydroquinone-dihydroxyethyl ether,
c) ester diols of the general formulae (I) and (II)
   HO—(CH₂)ₓ—CO—O—(CH₂)_{y}—OH (I),
   HO—(CH₂)ₓ—O—CO—R—CO—O(CH₂)ₓ—OH (II),
in which
R is an alkylene or arylene radical having from 1 to 10 carbon atoms, preferably from 2 to 6 carbon atoms,
x is from 2 to 6 and
y is from 3 to 5,
such as, for example, δ-hydroxybutyl-ε-hydroxy-caproic acid ester, ω-hydroxyhexyl-γ-hydroxybutyric acid ester, adipic acid (β-hydroxy-ethyl)ester and terephthalic acid bis(β-hydroxyethyl)ester, and
d) di- and poly-amines, such as, for example, 1,2-diaminoethane, 1,3-diaminopropane, 1,6-diaminohexane, 1,3- and 1,4-phenylenediamine, 4,4′-diphenylmethanediamine, isophoronediamine, isomeric mixture of 2,2,4- and 2,4,4-trimethylhexamethylenediamine, 2-methyl-pentamethylenediamine, diethylene-triamine, 1,3- and 1,4-xylylenediamine, α,α,α′,α′-tetramethyl-1,3- and -1,4-xylylenediamine, 4,4-diaminodicyclohexylmethane, amino-functional polyethylene oxides or polypropylene oxides, which are obtainable under the name Jeffamin®, D series (Huntsman Corp. Europe, Belgium), diethylenetriamine and triethylenetetramine. Suitable diamines within the scope of the invention are also hydrazine, hydrazine hydrate and substituted hydrazines, such as, for example, N-methylhydrazine, N,N′-dimethylhydrazine and their homologues, as well as acid dihydrazides, adipic acid, β-methyladipic acid, sebacic acid, hydracrylic acid and terephthalic acid, semicarbazido-alkylene hydrazides, such as, for example, β-semicarbazidopropionic acid hydrazide (described e.g. in DE-A 1 770 591), semicarbazidoalkylene-carbazine esters, such as, for example, 2-semicarbazidoethylcarbazine ester (described e.g. in DE-A 1 918 504) or aminosemicarbazide compounds, such as, for example, β-aminoethylsemicarbazido-carbonate (described e.g. in DE-A 1 902 931).

Component (A4) contains ionic groups which may be either cationic or anionic in nature. Compounds having a cationically, anionically dispersing action are those which, for example, sulfonium, ammonium, phosphonium, carboxylate, sulfonate, phosphonate groups or the groups that can be converted into the above-mentioned groups by salt formation (potentially ionic groups) and can be incorporated into the macromolecules by isocyanate-reactive groups that are present. Preferred suitable isocyanate-reactive groups are hydroxyl and amine groups.

Suitable ionic or potentially ionic compounds (A4) are, for example, mono- and di-hydroxycarboxylic acids, mono- and di-aminocarboxylic acids, mono- and di-hydroxysulfonic acids, mono- and di-aminosulfonic acids and mono- and di-hydroxyphosphonic acids or mono- and di-aminophosphonic acids and their salts, such as dimethylolpropionic acid, dimethylolbutyric acid, hydroxypivalic acid, N-(2-aminoethyl)-β-alanine, 2-(2-amino-ethylamino)-ethanesulfonic acid, ethylene-diamine-propyl-or -butyl-sulfonic acid, 1,2- or 1,3-propylenediamine-β-ethyl-sulfonic acid, malic acid, citric acid, glycolic acid, lactic acid, glycine, alanine, taurine, lysine, 3,5-diaminobenzoic acid, an addition product of IPDI and acrylic acid (EP-A 0 916 647, Example 1) and its alkali and/or ammonium salts; the adduct of sodium bisulfite with 2-butene-1,4-diol, polyethersulfonate, the propoxylated adduct of 2-butenediol and NaHSO₃, described e.g. in DE-A 2 446 440 (pages 5-9, formulae I-III) and also components which can be converted into cationic groups, such as N-methyl-diethanolamine, as hydrophilic structural components. Preferred ionic or potentially ionic compounds are those which have carboxy or carboxylate and/or sulfonate groups and/or ammonium groups. Particularly preferred ionic compounds are those which contain carboxyl and/or sulfonate groups as ionic or potentially ionic groups, such as the salts of N-(2-aminoethyl)-β-alanine, of 2-(2-amino-ethylamino)ethanesulfonic acid or of the addition product of IPDI and acrylic acid (EP-A 0 916 647, Example 1) and of dimethylolpropionic acid.

Suitable compounds having a non-ionically hydrophilising action (A5) are, for example, polyoxyalkylene ethers which contain at least one hydroxy or amino group. These polyethers contain an amount of from 30 wt. % to 100 wt. % of components derived from ethylene oxide. There are suitable polyethers of linear structure having a functionality of from 1 to 3, as well as compounds of the general formula (III) 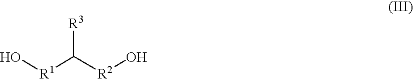
in which
R¹ and R² each independently of the other represents a divalent aliphatic, cycloaliphatic or aromatic radical having from 1 to 18 carbon atoms, which may be interrupted by oxygen and/or nitrogen atoms, and
R³ represents an alkoxy-terminated polyethylene oxide radical.

Compounds having a non-ionically hydrophilising action are, for example, also monohydric polyalkylene oxide polyether alcohols which have in the statistical mean from 5 to 70, preferably from 7 to 55, ethylene oxide units per molecule and are obtainable in a manner known per se by alkoxylation of suitable starter molecules (e.g. in Ullmanns Encyclopädie der technischen Chemie, 4th edition, Volume 19, Verlag Chemie, Weinheim p. 31-38).

Suitable starter molecules are, for example, saturated monoalcohols such as methanol, ethanol, n-propanol, isopropanol, n-butanol, isobutanol, sec.-butanol, the isomers of pentanol, hexanol, octanol and nonanol, n-decanol, n-dodecanol, n-tetradecanol, n-hexadecanol, n-octadecanol, cyclohexanol, the isomers of methylcyclohexanol or hydroxymethylcyclohexane, 3-ethyl-3-hydroxymethyl-oxetan or tetrahydrofurfuryl alcohol, diethylene glycol monoalkyl ethers, such as, for example, diethylene glycol monobutyl ether, unsaturated alcohols such as allyl alcohol, 1,1-dimethylallyl alcohol or oleic alcohol, aromatic alcohols such as phenol, the isomers of cresol and methoxyphenol, araliphatic alcohols such as benzyl alcohol, anisic alcohol or cinnamyl alcohol, secondary monoamines such as dimethylamine, diethylamine, dipropylamine, diisopropylamine, dibutylamine, bis-(2-ethylhexyl)-amine, N-methyl- and N-ethyl-cyclohexylamine or dicyclo-hexylamine, as well as heterocyclic secondary amines such as morpholine, pyrrolidine, piperidine or 1H-pyrazole. Preferred starter molecules are saturated monoalcohols. Particular preference is given to the use of diethylene glycol monobutyl ether as the starter molecule.

Suitable alkylene oxides for the alkoxylation reaction are especially ethylene oxide and propylene oxide, which can be used in the alkoxylation reaction in any desired sequence or alternatively in admixture.

The polyalkylene oxide polyether alcohols are either pure polyethylene oxide polyethers or mixed polyalkylene oxide polyethers whose alkylene oxide units consist of at least 30 mol. %, preferably at least 40 mol. %, of ethylene oxide units. Preferred non-ionic compounds are monofunctional mixed polyalkylene oxide polyethers which contain at least 40 mol. % ethylene oxide units and not more than 60 mol. % propylene oxide units.

A combination of non-ionic (A4) and ionic (A5) hydrophilising agents is preferably used for the preparation of the polyurethane (A). Particular preference is given to combinations of non-ionic and anionic hydrophilising agents.

The preparation of the aqueous polyurethane (A) can be carried out in one or more steps in homogeneous phase or, in the case of a multi-step reaction, partially in disperse phase. After complete or partial polyaddition, a dispersing, emulsifying or dissolving step is carried out. A further polyaddition or modification in disperse phase is optionally carried out thereafter.

For the preparation of the polyurethane (A) there may be used any processes known from the prior art, such as emulsifier shear force, acetone, prepolymer mixing, melt emulsification, ketimine and solids spontaneous dispersion processes or derivatives thereof. A summary of these methods is found in Methoden der organischen Chemie (Houben-Weyl, additional and following volumes to the 4th edition, Volume E20, H. Bartl and J. Falbe, Stuttgart, N.Y., Thieme 1987, p. 1671-1682). Preference is given to the melt emulsification, prepolymer mixing and acetone processes. The acetone process is particularly preferred.

In order to prepare a polyurethane prepolymer, some or all of constituents (A2) to (A5), which do not contain primary or secondary amino groups, and a polyisocyanate (A1) are usually placed in the reactor and, optionally diluted with a solvent that is Water-miscible but inert towards isocyanate groups, but preferably without solvents, heated to relatively high temperatures, preferably in the range of from 50 to 120° C.

Suitable solvents are, for example, acetone, butanone, tetrahydrofuran, dioxane, acetonitrile, dipropylene glycol dimethyl ether and 1-methyl-2-pyrrolidone, which can be added not only at the beginning of the preparation but optionally also later in portions. Acetone and butanone are preferred. It is possible to carry out the reaction under normal pressure or elevated pressure, e.g. above the normal pressure-boiling temperature of a solvent such as, for example, acetone.

It is also possible for the catalysts that are known to accelerate the isocyanate addition reaction, such as, for example, triethylamine, 1,4-diazabicyclo-[2,2,2]-octane, dibutyltin oxide, tin dioctoate or dibutyltin dilaurate, tin bis-(2-ethylhexanoate) or other organometallic compounds, to be placed in the reactor at the same time as the constituents or to be metered in later. Dibutyltin dilaurate is preferred.

Any of the constituents (A1), (A2), optionally (A3) and (A4) and/or (A5) which were not added at the beginning of the reaction, which constituents do not contain primary or secondary amino groups, are then metered in. In the preparation of the polyurethane prepolymer, the ratio of isocyanate groups to isocyanate-reactive groups is from 0.90 to 3, preferably from 0.95 to 2.5, particularly preferably from 1.05 to 2.0. The conversion of components (A1) to (A5) is carried out, based on the total amount of isocyanate-reactive groups of the part of (A2) to (A5) that does not contain primary or secondary amino groups, partially or completely, but preferably completely. The degree of conversion is usually monitored by following the NCO content of the reaction mixture. Both spectroscopic measurements, e.g. infrared or near infrared spectra, determinations of the refractive index and also chemical analyses, such as titrations, of removed samples can be carried out for that purpose. Polyurethane prepolymers that contain free isocyanate groups are obtained in solvent-free form or in solution.

After or during the preparation of the polyurethane prepolymers from (A1) and (A2) to (A5), the partial or complete salt formation of the groups having anionically and/or cationically dispersing action is carried out if it has not been carried out in the starting molecules. In the case of anionic groups, bases such as ammonia, ammonium carbonate or hydrogen carbonate, trimethylamine, triethylamine, tributylamine, diisopropylethylamine, dimethylethanolamine, diethylethanolamine, triethanolamine, potassium hydroxide or sodium carbonate are used for this purpose, preferably triethylamine, triethanolamine, dimethyl-ethanolamine or diisopropylethylamine. The amount of bases is from 50 to 100%, preferably from 60 to 90%, of the amount of anionic groups. In the case of cationic groups, sulfuric acid dimethyl ester or succinic acid is used. If only non-ionically hydrophilised compounds (A5) having ether groups are used, the neutralisation step is omitted. The neutralisation can also be carried out at the same time as the dispersion if the water used for the dispersion already contains the neutralising agent.

Possible amine components are (A2), (A3) and (A4) with which any remaining isocyanate groups can be converted. This chain lengthening can be carried out either in solvents before the dispersion, during the dispersion or in water after the dispersion. If amine components are used as (A4), the chain lengthening is preferably carried out before the dispersion.

The amine component (A2), (A3) or (A4) can be added to the reaction mixture diluted with organic solvents and/or with water. From 70 to 95 wt. % of solvent and/or water are preferably used. If more than one amine component is present, the conversions can be carried out in succession in any desired sequence or simultaneously by addition of a mixture.

For the purpose of preparing the polyurethane dispersion (A), the polyurethane prepolymers, optionally with pronounced shear, e.g. vigorous stirring, are either introduced into the water used for the dispersion or, conversely, the water used for the dispersion is stirred into the prepolymers. Then, if not carried out in the homogeneous phase, the increase in molar mass can be effected by reaction of any isocyanate groups present with the component (A2), (A3). The amount of polyamine (A2), (A3) used is dependent on the unconverted isocyanate groups present. From 50 to 100%, particularly preferably from 75 to 95%, of the amount of isocyanate groups are preferably converted with polyamines (A2), (A3).

The organic solvent can optionally be distilled off. The dispersions have a solids content of from 10 to 70 wt. %, preferably from 25 to −65 wt. % and particularly preferably from 30 to 60 wt. %.

The coating systems according to the invention can be used alone or together with binders, auxiliary substances and additives known in coating technology, especially light stabilisers such as UV absorbers and sterically hindered amines (HALS), also antioxidants, fillers and coating aids, e.g. anti-settling agents, anti-foams and/or wetting agents, flow agents, reactive diluents, plasticisers, catalysts, auxiliary solvents and/or thickeners and additives, such as, for example, dispersions, pigments, colourings or mattifying agents. In particular, combinations with other binders such as polyurethane dispersions or polyacrylate dispersions, which may optionally also be hydroxy-functional, are possible without difficulty. The additives can be added to the coating system according to the invention immediately before processing. However, it is also possible to add at least some of the additives before or during the dispersion of the binder or binder/crosslinker mixture. The choice and metering of these substances, which can be added to the individual components and/or to the mixture as a whole, are known to the person skilled in the art.

Polychloroprene production has been known for a long time; it is carried out by emulsion polymerisation in an alkaline aqueous medium, see “Ullmanns Encyclopädie der technischen Chemie”, Volume 9, p. 366, Verlag Urban and Schwarzenberg, Munich-Berlin 1957; “Encyclopedia of Polymer Science and Technology”; Vol. 3, p. 705-730, John Wiley, New York 1965; “Methoden der Organischen Chemie” (Houben-Weyl) XIV/1, 738 ff Georg Thieme Verlag Stuttgart 1961.

There come into consideration as emulsifiers in principle any compounds and their mixtures which stabilise the emulsion sufficiently, such as, for example, the water-soluble salts, especially the sodium, potassium and ammonium salts, of long-chain fatty acids, colophony and colophony derivatives, higher molecular weight alcohol sulfates, arylsulfonic acids, formaldehyde condensation products of arylsulfonic acids, non-ionic emulsifiers based on polyethylene oxide and polypropylene oxide, and also polymers having an emulsifying action, such as polyvinyl alcohol (DE-A 2 307 811, DE-A 2 426 012, DE-A 2 514 666, DE-A 2 527 320, DE-A 2 755 074, DE-A 3 246 748, DE-A 1 271 405, DE-A 1 301 502, U.S. Pat. No. 2,234,215, JP-A 60 031 510).

The object was, therefore, to provide an aqueous polychloroprene dispersion which is distinguished by long storage stability, i.e. whose pH does not change significantly during the storage period.

The object was achieved by the provision of an aqueous polychloroprene dispersion, obtainable by continuous or discontinuous polymerisation of chloroprene in aqueous emulsion, with or without the addition of only a small amount of a regulator, removal of the residual monomer and storage under specific conditions, it being possible for the desired polymer structure to be established in a targeted manner.

Accordingly, there are used in accordance with the invention polychloroprene dispersions which are obtainable by polymerisation, in an alkaline medium, of chloroprene and from 0 to 20 parts by weight of an ethylenically unsaturated monomer which is copolymerisable with chloroprene.

Suitable copolymerisable monomers are described, for example, in “Methoden der Organischen Chemie” (Houben-Weyl) XIV/1, 738 ff Georg Thieme Verlag Stuttgart 1961. Preference is given to compounds having from 3 to 12 carbon atoms and 1 or 2 copolymerisable C═C double bonds per molecule. Examples of preferred copolymerisable monomers are 2,3-dichlorobutadiene and 1-chlorobutadiene.

The polychloroprene dispersion to be used according to the invention is prepared by emulsion polymerisation at from 0 to 70° C., preferably at from 5 to 45° C., and pH values of from 10 to 14, preferably from pH 11 to pH 13. Activation is effected by means of the conventional activators or activator systems.

The polychloroprene dispersion has a particle diameter of 60 to 300 nm, preferably 60 to 200 nm, more preferably from 60 to 150 nm and most preferably from 60 to 120 nm.

The following may be mentioned as examples of activators and activator systems: formamidinesulfinic acid, potassium peroxodisulfate, redox systems based on potassium peroxodisulfate and optionally silver salt (Na salt of anthraquinone-β-sulfonic acid), wherein compounds such as, for example, formamidinesulfinic acid, the Na salt of hydroxymethanesulfinic acid, sodium sulfite and sodium dithionite serve as redox partner. Redox systems based on peroxides and hydroperoxides are also suitable. The preparation of the polychloroprenes according to the invention can be carried out either continuously or discontinuously, continuous polymerisation being preferred.

In order to adjust the viscosity of the polychloroprenes according to the invention there may be used conventional chain-transfer agents such as mercaptans, as described, for example, in DE-A 3 002 711, GB-A 1 048 235, FR-A 2 073 106, or xanthogen disulfides, as described, for example, in DE-A 1 186 215, DE-A 2 156 453, DE-A2306610 and DE-A3044811, in EP-A0053319, GB-A 512 458, GB-A 952 156 and U.S. Pat. No. 2,321,693 and U.S. Pat. No. 2,567,117.

Particularly preferred chain-transfer agents are n-dodecylmercaptan and the xanthogen disulfides used according to DE-A 3 044 811, DE-A 2 306 610 and DE-A 2 156 453.

The polymerisation is usually terminated at from 50% to 95%, preferably at from 60% to 80%, of the monomer conversion, it being possible to add as inhibitor, for example, phenothiazine, tert.-butylpyrocatechol or diethylhydroxylamine. In this radical emulsion polymerisation, the monomer is incorporated into the growing polymer chain at different positions, for example at a polymerisation temperature of 42° C. 92.5% in the trans-1,4 position, 5.2% in the cis-1,2-position, 1.2% in the 1,2-position and 1.1% in the 3,4-position (W. Obrecht in Houben-Weyl: Methoden der organischen Chemie Vol. 20 Part 3 Makromolekulare Stoffe, (1987) p. 845), the monomer incorporated at the 1,2-position containing a labile, readily cleavable chlorine atom. This is the active species via which vulcanisation with metal oxides takes place.

After the polymerisation, the residual chloroprene monomer is removed by steam distillation. It is carried out as described, for example, in “W. Obrecht in Houben-Weyl: Methoden der organischen Chemie Vol. 20 Part 3 Makromolekulare Stoffe, (1987) p. 852”.

The low-monomer polychloroprene dispersion prepared in this manner is then stored at relatively high temperatures. During this time, some of the labile chlorine atoms are separated off and a polychloroprene network that is insoluble in organic solvents (gel) is formed.

In a further step, the solids content of the dispersion is increased by means of a creaming process. This creaming is carried out, for example, by addition of alginates, as described in “Neoprene Latices, John C. Carl, E.I. Du Pont 1964, p. 13”.

Accordingly, the present invention relates also to the preparation of a storage-stable polychloroprene dispersion by:
polymerisation of chloroprene in the presence of from 0 to 1 mmol. of a regulator, based on 100 g of monomer, preferably from 0 to 0.25 mmol., at temperatures of from 0° C. to 70° C., preferably from 5° C. to 45° C., particularly preferably at from 10° C. to 25° C., the dispersion having a fraction that is insoluble in organic solvents of from 0.1 to 30 wt. %, preferably from 0.5 to 5 wt. %, based on the polymer,
removal of the residual, unpolymerised monomer by steam distillation,
storage of the dispersion at temperatures of from 50° C. to 110° C., preferably from 60° C. to 100° C., particularly preferably from 70° C. to 90° C., the fraction that is insoluble in organic solvents (gel fraction) increasing to from 1 wt. % to 60 wt. %, this lasts from 3 hours to 14 days according to the system and is to be determined by orienting preliminary tests,
increasing the solids content to from 50 to 64 wt. %, preferably from 52 to 59 wt. %, by a creaming process, yielding a dispersion having a very low salt content, especially a low content of chloride ions, which is particularly preferably less than 500 ppm.

Aqueous dispersions of silicon dioxide have been known for a long time. They have different structures, depending on the preparation process.

Silicon dioxide dispersions b) suitable according to the invention can be obtained on the basis of silica sol, silica gel, pyrogenic silicic acids or precipitated silicic acids or mixtures thereof.

Silicic acid sols are colloidal solutions of amorphous silicon dioxide in water, which are also known as silicon dioxide sols but are mostly abbreviated to silica sols. The silicon dioxide is in the form of spherical particles which have been hydroxylated at the surface. The particle diameter of the colloid particles is generally from 1 to 200 nm, the specific BET surface area (determined by the method of G. N. Sears, Analytical Chemistry Vol. 28, N. 12, 1981-1983, December 1956, the relevant portions of which are herein incorporated by reference) correlating with the particle size being from 15 to 2000 m²/g. The surface of the SiO₂ particles has a charge which is compensated by a corresponding counter-ion, leading to stabilisation of the colloidal solution. The alkaline-stabilised silica sols have a pH value of from 7 to 11.5 and contain as alkalinising agent, for example, small amounts of Na₂O, K₂O, Li₂O, ammonia, organic nitrogen bases, tetraalkylammonium hydroxides or alkali or ammonium aluminates. Silica sols may also be in weakly acidic form as semi-stable colloidal solutions. It is also possible, by coating the surface with Al₂(OH)₅Cl, to prepare cationically adjusted silica sols. The solids concentration of the silica sols is from 5 to 60 wt. % SiO₂.

The preparation process for silica sols passes substantially through the production steps dealkalinisation of water glass by means of ion exchange, establishment and stabilisation of the desired particle size (distribution) of the SiO₂ particles, establishment of the desired SiO₂ concentration and optionally surface modification of the SiO₂ particles, for example using Al₂(OH)₅Cl. The SiO₂ particles do not leave the colloidally dissolved state in any of these steps. This explains the presence of the discrete primary particles having, for example, high binding effectiveness.

Silica gels are understood to be colloidally formed or unformed silicic acids of elastic to solid consistency having a loose to dense pore structure. The silicic acid is in the form of highly condensed polysilicic acid. Siloxane and/or silanol groups are located on the surface. Silica gels are prepared from water glass by reaction with mineral acids.

Furthermore, a distinction is made between pyrogenic silicic acid and precipitated silicic acid. In the precipitation process, water is placed in a vessel and then water glass and acid, such as H₂SO₄, are added simultaneously. This yields colloidal primary particles, which agglomerate as the reaction proceeds and grow together to form agglomerates. The specific surface area is from 30 to 800 m²/g (DIN 66131) and the primary particle size is from 5 to 100 nm. The primary particles of these silicic acids in solid form are firmly crosslinked to form secondary agglomerates.

Pyrogenic silicic acid can be prepared by flame hydrolysis or with the aid of the arc process. The dominant synthesis process for pyrogenic silicic acids is flame hydrolysis, in which tetrachlorosilane is decomposed in an oxyhydrogen flame.

The silicic acid formed thereby is amorphous to X-rays. Pyrogenic silicic acids have markedly fewer OH groups on their virtually pore-free surface than precipitated silicic acid. Pyrogenic silicic acid produced by flame hydrolysis has a specific surface area of from 50 to 600 m²/g (DIN 66131) and a primary particle size of from 5 to 50 nm; silicic acid produced by the arc process has a specific surface area of from 25 to 300 m²/g (DIN 66131) and a primary particle size of from 5 to 500 nm.

Further information regarding the synthesis and properties of silicic acids in solid form is to be found, for example, in K. H. Büchel, H.-H. Moretto, P. Woditsch “Industrielle Anorganische Chemie”, Wiley VCH Verlag 1999, Chap. 5.8.

If an SiO₂ raw material in the form of an isolated solid, for example pyrogenic or precipitated silicic acid, is used for the polymer dispersion according to the invention, then it is converted into an aqueous SiO₂ dispersion by dispersion.

Dispersing machines of the prior art are used to produce the silicon dioxide dispersions, preferably dispersing machines suitable for producing high shear rates, for example Ultratorrax or dissolver plates.

Preference is given to the use of aqueous silicon dioxide dispersions whose SiO₂ particles have a primary particle size of from 1 to 400 nm, preferably from 5 to 100 nm and particularly preferably from 8 to 60 nm. Where precipitated silicic acids are used, these are ground in order to comminute the particles.

Preferred polymer dispersions according to the invention are those in which the SiO₂ particles of the silicon dioxide dispersion b) are in the form of discrete, uncrosslinked primary particles.

It is also preferred for the SiO₂ particles to have hydroxyl groups at the particle surface.

Particular preference is given to the use of aqueous silicic acid sols as the aqueous silicon dioxide dispersions.

A property of the silicic acids according to the invention is their thickening action in formulations of polyurethane and polychloroprene dispersions, with the result that the adhesives so produced form finely divided dispersions which are stable to sedimentation, can readily be processed and have high stability even on porous substrates that are to be bonded.

This thickening action of the silicon dioxide dispersions is accelerated by additives such as zinc oxide or other metal oxides which have amphoteric nature and partially hydrolyse.

In order to produce the polymer dispersions according to the invention, the ratios of the individual components are so chosen that the resulting dispersion has a content of dispersed polymers of from 30 to 60 wt. %, the amount of polyurethane dispersion (a) being from 55 to 99 wt. % and the amount of silicon dioxide dispersion (b) being from 1 to 45 wt. %, the percentages being based on the weight of non-volatile constituents and totalling 100 wt. %.

The polymer dispersions according to the invention preferably contain an amount of from 70 wt. % to 98 wt. % of a mixture of polychloroprene and polyurethane dispersion (a) and an amount of from 2 wt. % to 30 wt. % of a silica sol dispersion (b), particular preference being given to mixtures of from 80 wt. % to 93 wt. % of polymer dispersion (a) and from 20 wt. % to 7 wt. % of dispersion (b), the percentages being based on the weight of non-volatile constituents and totalling 100 wt. %.

In the mixture of polyurethane and polychloroprene dispersions according to the invention, the amount of polyurethane dispersion is from 10% to 80%, preferably from 20% to 50%.

The polymer mixture may optionally also contain other dispersions, such as, for example, polyacrylate, polyvinylidene chloride, polybutadiene, polyvinyl acetate or styrene-butadiene dispersions, in an amount of up to 30 wt. %.

The polymer dispersions according to the invention contain further additives and optionally adhesive auxiliary substances. For example, it is possible to add fillers such as quartz powder, quartz sand, heavy spar, calcium carbonate, chalk, dolomite or talcum, optionally together with wetting agents, for example polyphosphates such as sodium hexametaphosphate, naphthalenesulfonic acid, ammonium or sodium polyacrylic acid salt, the fillers being added in amounts of from 0.10 to 60 wt. %, preferably from 20 to 50 wt. %, and the wetting agents being added in amounts of from 0.2 to 0.6 wt. %, all figures being based on non-volatile constituents.

For the production of highly transparent adhesive films, for example, there may be used as additives epoxides (Ruetapox® 0164; bisphenol A epichlorohydrin resin MW≧700, viscosity: 8000-13000 mPas, supplier: Bakelite AG, Varzinger Str. 49, 47138 Duisburg-Meiderich). There is preferably used as additive zinc oxide or magnesium oxide, as an acceptor for small amounts of hydrogen chloride which may be separated off from the chloroprene polymers. These are added in amounts of from 0.1 to 10 wt. %, preferably from 1 to 5 wt. %, based on the non-volatile constituents, and can hydrolyse partially in the presence of the polychloroprene dispersions (a) or contain hydrolysable constituents. In this manner, the viscosity of the polymer dispersion can be increased and adjusted to a desired level. This hydrolysis is described for ZnO, for example, in “Gmelins Handbuch der anorganischen Chemie”, 8th edition, 1924, Verlag Chemie Leipzig, Vol. 32, p. 134/135 and in the additional volume 32, Verlag Chemie, 1956, p. 1001-1003. It is described for MgO, for example, in “Gmelins Handbuch der anorganischen Chemie”, 8th edition, 1939, Verlag Chemie Berlin, Vol. 27, p. 12/13, 47-50, 62-64.

Further suitable auxiliary substances which may optionally be used are, for example, organic thickeners which are to be used in amounts of from 0.01 to 1 wt. %, based on non-volatile constituents, such as cellulose derivatives, alginates, starches, starch derivatives, polyurethane thickeners or polyacrylic acid, or inorganic thickeners which are to be used in amounts of from 0.05 to 5 wt. %, based on non-volatile constituents, such as, for example, bentonites.

Fungicides may also be added to the adhesive composition according to the invention for the purpose of preservation. These are used in amounts of from 0.02 to 1 wt. %, based on non-volatile constituents. Suitable fungicides are, for example, phenol and cresol derivatives or organotin compounds.

It is also possible to add to the polymer dispersion according to the invention, in dispersed form, tackifying resins, such as, for example, unmodified or modified natural resins such as colophony esters, hydrocarbon resins, or synthetic resins such as phthalate resins (see e.g. “Klebharze” R. Jordan, R. Hinterwaldner, p 75-115, Hinterwaldner Verlag Munich 1994). Preference is given to alkylphenol resin and terpenephenol resin dispersions having softening points greater than 70° C., particularly preferably greater than 110° C.

It is also possible to use organic solvents, such as, for example, toluene, acetone, xylene, butyl acetate, methyl ethyl ketone, ethyl acetate, dioxane or mixtures thereof, or plasticisers, such as, for example, those based on adipate, phthalate or phophate, in amounts of from 0.5 to 10 parts by weight, based on non-volatile constituents.

The invention also provides a process for the preparation of the polymer dispersions according to the invention, characterised in that the polychloroprene dispersion is mixed with the silicon dioxide dispersion (b), and the polyurethane dispersion is then added, the viscosity of the polychloroprene-silicon dioxide mixture falling. Conventional adhesive auxiliary substances and additives may optionally be added.

The adhesive formulation can be applied in known ways, e.g. by spread coating, pouring, knife application, spraying, roller application or immersion. Drying of the adhesive film can be carried out at room temperature or elevated temperature up to 220° C.

The adhesive formulations can be used in single-component form or, in known manner, with the use of crosslinkers. The adhesive layers can additionally be vulcanised by heating for a short time (seconds to a few minutes) at temperatures of from 150 to 180° C.

The adhesives according to the invention additionally exhibit a markedly reduced tendency to yellowing in comparison with conventional polychloroprene adhesives. They adhere to plasticised PVC without activation, and they exhibit good wet adhesion properties on synthetic leather (Mesh), which is difficult to bond.

The bonds retain their high quality because they are not damaged by hydrolysis.

The polymer dispersions according to the invention can be used as adhesives, for example for the adhesive bonding of any desired substrates of the same type or of different types, such as wood, paper, plastics, textiles, leather, rubber or inorganic materials such as ceramics, stoneware, glass fibres or cement.

### EXAMPLES

1.1 Substances Used

TABLE 1
Polyurethane and polychloroprene dispersions

| Dispersion | Product | Supplied form | Supplier |
|---|---|---|---|
| A | Dispercoll ® C | 58% aqueous poly-2- | Bayer |
| | VPLS 2325 | chlorobutadiene-(1,3) | MaterialScience |
| | | dispersion having a | AG |
| | | pronounced tendency to | |
| | | crystallise | |
| | | pH about 13 | |
| | | (according to DIN | |
| | | 53606) | |
| B | Dispercoll ® | 50% dispersion of an | Bayer |
| | U 54 | aliphatic hydroxyl- | MaterialScience |
| | | polyester polyurethane; | AG |
| | | particle diameter 200 nm | |
| | | minimum activating | |
| | | temperature: 45-55°C. | |
| | | pH 6.0-9.0 | |

TABLE 2
Silicon dioxides

| Product | Supplier | Supplied form | Type |
|---|---|---|---|
| Dispercoll ® S | Bayer | Silica sol dispersion, | Silica sol |
| 5005 | MaterialScience | 50%, BET 50 m²/g, | |
| | AG, Lev., DE | pH 9, | |
| | | particle size 50 nm | |
| Dispercoll ® S | Bayer | Silica sol dispersion, | Silica sol |
| 3030 | MaterialScience | 30%, BET 300 m²/g, | |
| | AG, Lev., DE | pH 10, | |
| | | particle size 9 nm | |

Preparation of the Polychloroprene Dispersion:
Example (Dispercoll® C VPLS 2325)
A1 Polymerisation

Into the first reactor of a polymerisation cascade consisting of 7 identical reactors each having a volume of 50 litres there are introduced the aqueous phase (W) and the monomer phase (M), via a measuring and regulating apparatus, in a constant ratio, as well as the activator phase (A). The mean residence time per vessel is 25 minutes. The reactors correspond to those described in DE-A 2 650 714 (figures in parts by weight per 100 g parts by weight of monomers used).

| (M) = monomer phase: | | |
|---|---|---|
| chloroprene | 100.0 | parts by weight |
| n-dodecylmercaptan | 0.03 | part by weight |
| phenothiazine | 0.005 | part by weight |
| (W) = aqueous phase: | | |
| demineralised water | 115.0 | parts by weight |
| sodium salt of a disproportionated abietic acid | 2.6 | parts by weight |
| potassium hydroxide | 1.0 | part by weight |
| (A) = activator phase: | | |
| 1% aqueous formamidinesulfinic acid solution | 0.05 | part by weight |
| potassium persulfate | 0.05 | part by weight |
| anthraquinone-2-sulfonic acid Na salt | 0.005 | part by weight |

At an internal temperature of 15° C., the reaction starts slightly. The heat of polymerisation that is liberated is dissipated by external cooling and the polymerisation temperature is maintained at 10° C. At a monomer conversion of 80%, the reaction is terminated by addition of diethylhydroxylamine. The residual monomer is removed from the polymer by steam distillation. The solids content is 38 wt. %, the gel content is 4 wt. %, the pH is 12.8.

After a polymerisation time of 120 hours, the polymerisation line is run down.

A2) Tempering of the Dispersion

After the steam distillation, the dispersions are tempered in an insulated storage tank for 2 days at a temperature of 80° C., the temperature optionally being regulated by additional heating. The latex is then cooled and creamed (A3).

A3) Creaming Process

Solid alginate (Manutex) is dissolved in deionised water and a 2 wt. % alginate solution is prepared. 200 g of the polychloroprene dispersion are placed into each of eight 250 ml glass bottles, and from 6 to 20 g—in 2 g steps—of the alginate solution are stirred in. After a storage time of 24 hours, the amount of serum that has formed over the thick latex is measured. The amount of alginate in the sample having the most pronounced serum formation is multiplied by 5 and gives the optimum alginate amount for the creaming of 1 kg of polychloroprene dispersion.

1.2 Measuring Methods

1.2.1 Determination of the Peel Strength on Plasticised PVC at Room Temperature

The test is carried out according to EN 1392. Two plasticised PVC test specimens (30% dioctyl phthalate, DOP) measuring 100×30 mm are roughened with abrasive paper (coarseness=80) and the dispersion is applied to both sides thereof, to the roughened surface, by means of a brush and is dried at room temperature for 60 minutes. The test specimens are then placed together and pressed in a press (10 seconds; 4 bar line pressure). A tear test is carried out on a commercial tensile testing machine at room temperature. The strength values are determined immediately after bonding and after three days. The test specimens are stored at 23° C. and 50% relative humidity.

Application of Adhesive:

adhesive applied as a single component using a knife, 200 μm
   1.3 Production of the Adhesive Composition

For the production of the formulation, the polychloroprene dispersion is placed in a glass beaker. There are then added in succession the antioxidant Rhenofit® DDA-50 EM (N-phenylbenzeneamine, treated with styrene, solids content 50%, pH 8-10, manufacturer Rhein Chemie Rheinau GmbH), the zinc oxide in the form of the dispersion Borchers® 9802 (aqueous paste based on active zinc oxide, intrinsically viscous white paste, pigment content 50 wt. %, density about 1.66 g/cm³, viscosity about 35.00 mPas at 10.3 l/s; supplier Borchers GmbH, Alfred Nobel Str., 50, 40765 Monheim) and finally the silica sol. After a reaction time of 30 minutes, an intrinsically viscous mass has formed by gelling of the silica sol (CR(organic)-silicon dioxide/silica sol-(inorganic)-hybrid system), which is adjusted to the desired viscosity by addition of the polyurethane dispersion.

Bonding to PVC with 30% Plasticiser (Bonds Without Activation)

| | 1* | 2* | 3 | 4 | 5 | 6 | 7* |
|---|---|---|---|---|---|---|---|
| Dispercoll ® C2325 | 100 | 100 | 100 | 100 | 100 | 100 | |
| Dispercoll ® U 54 | — | — | 25 | 50 | 75 | 100 | 100 |
| Dispercoll ® S 3030 | — | 20 | 20 | 20 | 20 | 20 | — |
| Zinc oxide Borchers ® | 4 | 4 | 4 | 4 | 4 | 4 | — |
| 9802 | | | | | | | |
| Rhenofit ® DDA- | 2 | 2 | 2 | 2 | 2 | 2 | — |
| 50 EM | | | | | | | |
| Peel strength [N/mm] | 0.1 | 0.2 | 1.1 | 1.5 | 0.7 | 0.5 | 0 |
| immediate | | | | | | | |
| Peel strength [N/mm] | 0.2 | 0.3 | 1.5 | 1.5 | 0.6 | 0.5 | 0 |
| 1 d | | | | | | | |

*comparison

Bonding of Synthetic Leather (MESH) Using Adhesive No. 4

Synthetic leather composed of a PUR top layer with a textile side based on polyethylene terephthalate.

MESH is coated with the adhesive on the textile side and
without any aeration time, pressed together (textile side to textile side, so-called Umbugg process) by hand (with the fingertips) after a specific time (minutes)

after 90 seconds in a circulating-air cabinet at 65° C., pressed together (textile side to textile side, so-called Umbugg process) by hand (with the fingertips) after a specific time (minutes).

| | 0 | 4 | 6 | 8 | 10 | 12 | 15 |
|---|---|---|---|---|---|---|---|
| Minutes' storage at RT | | | | | | | |
| Formulation 4 = according | C | C | C | C | B | B | A |
| to the invention | | | | | | | |
| Formulation 2 = comparison | C | C | C | C | C | C | C |
| 90 seconds' storage at 65° C. | | | | | | | |
| Formulation 4 = according | A | A | A | A | A | A | A |
| to the invention | | | | | | | |
| Formulation 2 = comparison | C | C | C | C | C | C | C |

A: good strength
B: moderate bond
C: inadequate strength, poor bond

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. An aqueous polymer dispersion comprising
a) at least one polyurethane dispersion having a mean particle size of from 60 to 350 nm, and
b) at least one polychloroprene dispersion having a mean particle size of from 60 to 300 nm, and
c) at least one aqueous silicon dioxide dispersion having a particle diameter of the SiO₂ particles of from 1 to 400 nm.

2. The aqueous polymer dispersion according to claim 1, wherein the SiO₂ particles have a particle diameter of from 5 to 100 nm.

3. The aqueous polymer dispersion according to claim 1, wherein the SiO₂ particles have a particle diameter of from 8 to 60 nm.

4. The aqueous polymer dispersion according to claim 1, wherein the SiO₂ particles are in the form of discrete, uncrosslinked primary particles.

5. The aqueous polymer dispersion according to claim 1, wherein the SiO₂ particles have hydroxyl groups at the particle surface.

6. The aqueous polymer dispersion according to claim 1, wherein the aqueous silicon dioxide dispersion c) is an aqueous silicic acid sol.

7. A process for the preparation of the polymer dispersion according to claim 1, comprising mixing the polychloroprene dispersion (b) with the silicon dioxide dispersion (c) and optionally additives conventionally used as adhesive auxiliary substances, and mixing the polyurethane dispersion (a) into the mixture of (b) and (c).

8. An adhesive composition comprising the polymer dispersions according to claim 1.

9. Substrates bonded together by the polymer dispersion according to claim 1.

10. Substrates according to claim 9, wherein the substrates are structural components of shoes or are shoes.

11. The aqueous polymer dispersion according to claim 2, wherein the SiO₂ particles are in the form of discrete, uncrosslinked primary particles.

12. The aqueous polymer dispersion according to claim 3, wherein the SiO₂ particles are in the form of discrete, uncrosslinked primary particles.

13. The aqueous polymer dispersion according to claim 2, wherein the SiO₂ particles have hydroxyl groups at the particle surface.

14. The aqueous polymer dispersion according to claim 3, wherein the SiO₂ particles have hydroxyl groups at the particle surface.

15. The aqueous polymer dispersion according to claim 2, wherein the aqueous silicon dioxide dispersion c) is an aqueous silicic acid sol.

16. The aqueous polymer dispersion according to claim 3, wherein the aqueous silicon dioxide dispersion c) is an aqueous silicic acid sol.
